(19) United States
(12) Patent Application Publication
(10) Pub. No.: US 2014/0272883 A1
(43) Pub. Date: Sep. 18, 2014

(54) SYSTEMS, METHODS, AND APPARATUS FOR EQUALIZATION PREFERENCE LEARNING

(71) Applicant: Northwestern University, Evanston, IL (US)

(72) Inventors: Bryan Pardo, Evanston, IL (US); Alexander M. Madjar, North Royalton, OH (US); David Frank Little, Evanston, IL (US); Darren Gergle, Chicago, IL (US)

(73) Assignee: Northwestern University, Evanston, IL (US)

(21) Appl. No.: 14/207,900

(22) Filed: Mar. 13, 2014

Related U.S. Application Data
(60) Provisional application No. 61/783,580, filed on Mar. 14, 2013.

(51) Int. Cl. G09B 5/04

(52) U.S. Cl. CPC G09B 5/04
USPC 434/319

(57) ABSTRACT

Systems, methods, and apparatus for equalization preference learning are provided. An example method includes receiving a first label for a first audio concept for a media object and applying active learning to select a first example not yet rated by a first current user. The example method includes collecting a first user rating, by the first current user, of the first example compared to the first audio concept and applying transfer learning to combine the first user rating with ratings from prior users of examples not yet rated by the first current user to build a model of the first audio concept. The example method includes creating a tool operable by the first user to generate examples close to and far from the first label to modify the media object.

### CROSS-REFERENCE TO RELATED APPLICATIONS

This patent claims priority to U.S. Provisional Application Ser. No. 61/783,580, entitled “SYSTEMS, METHODS, AND APPARATUS FOR EQUALIZATION PREFERENCE LEARNING,” which was filed on Mar. 14, 2013, and is hereby incorporated herein by reference in its entirety.

### STATEMENT REGARDING FEDERALLY SPONSORED RESEARCH OR DEVELOPMENT

This invention was made with government support under Grant Numbers 1116384 and 0757544 awarded by the National Science Foundation. The government has certain rights in the invention.

### BACKGROUND

The presently described technology generally relates to digital audio modification. In particular, the presently described technology relates to systems, methods, and apparatus to facilitate and improve equalization preference learning for digital audio modification.

In recent decades, audio production tools have increased in performance and decreased in price. These trends have enabled an increasingly broad range of musicians, both professional and amateur, to use these tools to create music. Unfortunately, these tools are often complex and conceptualized in parameters that are unfamiliar to many users. As a result, potential users may be discouraged from using these tools, or may not use them to their fullest capacity.

The control parameters provided to users in audio production tools generally reflect the algorithm used to manipulate the sound rather than how manipulating that parameter will influence the way in which that sound is perceived. For example the parameters of an audio equalizer interface might provide the user the ability to manipulate certain frequencies. However, the perceptual effect of that manipulation might be to make the sound more “bright.” Many users approach an audio production tool with an idea of the perceptual effect that they would like to bring about, but may lack the technical knowledge to understand how to achieve that effect using the interface provided.

Equalizers affect the timbre and audibility of a sound by boosting or cutting the level in restricted regions of the frequency spectrum. These devices are widely used for many applications such as mixing and mastering music recordings. Many equalizers have interfaces that are daunting to inexperienced users. Thus, such users often use language to describe the desired change to an experienced individual (e.g., an audio engineer) who performs the equalization manipulation.

Using language to describe the desired change can be a significant bottleneck if the engineer and the novice do not agree on the meaning of the words used. While investigations of the physical correlates of commonly used adjectives have identified some descriptors for which there is considerable agreement across listeners, they have also identified individual differences. For instance, when using the descriptors “warm” and “clear” to describe the timbre of pipe organs, English speakers from the United Kingdom disagreed with those from the United States on the acoustical correlate.

Further complicating the use of language, the same equalizer adjustment might lead to perception of different descriptors depending on the spectrum of the sound source. For example, a boost to the midrange frequencies might “brighten” a sound with energy concentrated in the low-frequencies (e.g., a bass), but might make a more broadband sound (e.g., a piano) appear “tinny.” Thus, though there have been several recent attempts to directly map equalizer settings to commonly used descriptors, there are several difficulties to this approach.

An alternative approach that circumvents these problems learns a listener's preference on a case-by-case basis. Perhaps the most studied procedure of this type has been developed for setting the equalization curve of a hearing aid. In what is known as a modified simplex procedure, the spectrum is divided into a low- and a high-frequency channel and each combination of low- and high-frequency gains is represented as points on a grid. On each trial, the listener makes two paired preference judgments: one in which the two settings differ in high frequency gain, and one in which they differ in low frequency gain. The subsequent settings are selected to move in the direction of the preference. Once there is a reversal on both axes, the procedure is complete and the gains are set. While this procedure can be relatively quick, the number of potential equalization curves explored is quite small. Although this procedure could theoretically be expanded to include more variables, the amount of time that this would take quickly becomes prohibitively large.

### BRIEF DESCRIPTION OF SEVERAL VIEWS OF THE DRAWINGS

FIG. 1 illustrates an example weighting function.

FIG. 2 demonstrates an example of weighting function quality.

FIG. 3 illustrates an example time course of learning.

FIG. 4 demonstrates example specificity to probe curves.

FIG. 5 illustrates individual audiograms and associated average weighting functions.

FIG. 6 depicts an example principle component analysis.

FIGS. 7-9 provide example interfaces used for training, verification, and feedback.

FIG. 10 provides a plurality of example weighting functions for a plurality of sounds based on normalized slope and frequency.

FIG. 11 summarizes an example simulation of machine ratings generated by computing the similarity of a given probe to the weighting function based on user ratings.

FIG. 12 illustrates an example interface of an application that allows sound adjustments to be made on digital audio equalizers.

FIG. 13 illustrates an example calibration system to calibrate an audio device based on learned user preference.

FIG. 14 illustrates an example flow diagram for a method for listener calibration using an equalization curve.

FIG. 15 shows learned equalization curves for three example user-concepts.

FIG. 16 illustrates a pool of rated examples for three user-concepts: warm, dark, and phat.

FIG. 17 shows the user-concepts from FIG. 16 in a space defined by user ratings of examples 2 and 3 from FIG. 16.

FIG. 18 shows an example interface for a parametric equalizer plug-in.

FIG. 19 depicts an example a personalized controller to control filtering of audio based on a learned model of audio manipulation.

FIG. 20 illustrates an example of a user rating how well each example sound exemplifies the user's descriptor.

FIG. 21 shows a learned equalization (EQ) curve provided for a single user's concept of “warm.”

FIG. 22 illustrates a flow diagram of an example method to personalize an audio equalizer interface based on user feedback through transfer and/or active learning.

FIG. 23 is a block diagram of an example processor system that may be used to implement systems, apparatus, and methods described herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EMBODIMENTS

### I. Brief Description

Certain examples provide methods and systems to improve speed and accuracy of learning user preferences for an audio product. For example, systems, methods, and apparatus are provided for equalization preference learning for digital audio modification.

Potential users of audio tools (e.g., for tasks such as music production, hearing aids, etc.) are often discouraged by the complexity of an interface used to tune the device to produce a desired sound. Pending patent application publication number 2011-0029111, entitled “Systems, Methods, and Apparatus for Equalization Preference Learning,” filed on Jul. 29, 2010, and herein incorporated by reference in its entirety, describes systems and methods to simplify this problem. The systems and methods learn settings by presenting a sequence of sounds to a user and correlating device parameter settings with the user's preference rating. Using this approach, the user rates roughly thirty sounds, for example.

Certain examples improve speed and accuracy of equalization preference learning by incorporating transfer learning and active learning. In certain examples, audio concepts (e.g. equalization settings) taught to a device by previous users are reused based on an assumption that a previous user's desired effect may be similar to a current user's desired effect. When teaching or training a system, similarity between two users can be estimated by determining how similar their responses were to the same set of examples. The more similar the set of ratings, the more relevant the prior ratings are to learning the current users' desired settings, for example. When prior data is properly applied, performance equal to the original system can be achieved by rating only one to three sounds instead of thirty, resulting in a ten- to thirty-fold speed increase, for example.

Certain examples increase learning of a desired setting for a hearing aid, audio equalizer, or other audio production tool by reducing a number of user ratings of sound examples (e.g., from roughly 30 to between 1 and 3). Certain examples improve performance as more people use the system.

Certain examples provide a method including receiving a first label for a first audio concept for a media object and applying active learning to select a first example not yet rated by a first current user. Certain examples include collecting a first user rating, by the first current user, of the first example compared to the first audio concept and applying transfer learning to combine the first user rating with ratings from prior users of examples not yet rated by the first current user to build a model of the first audio concept. Certain examples include creating a tool operable by the first user to generate examples close to and far from the first label to modify the media object.

Certain examples provide a system including a processor configured to generate an interface. The example interface receives a first label for a first audio concept for a media object. The example processor is configured to apply active learning to select a first example not yet rated by a first current user. The example processor is configured to collect a first user rating, by the first current user, of the first example compared to the first audio concept. The example processor is configured to apply transfer learning to combine the first user rating with ratings from prior users of examples not yet rated by the first current user to build a model of the first audio concept. The example processor is configured to create a tool operable by the first user to generate examples close to and far from the first label to modify the media object.

Certain examples provide a tangible computer readable medium including computer program code which, when executed by a processor, implements a method. The example method includes receiving a first label for a first audio concept for a media object and applying active learning to select a first example not yet rated by a first current user. The example method includes collecting a first user rating, by the first current user, of the first example compared to the first audio concept and applying transfer learning to combine the first user rating with ratings from prior users of examples not yet rated by the first current user to build a model of the first audio concept. The example method includes creating a tool operable by the first user to generate examples close to and far from the first label to modify the media object.

Active learning may be applied to select an example that showed a largest variance in ratings given by prior users, for example. A weight assigned to the prior user's ratings may be based on a similarity between the prior user's ratings and the current user's ratings of the same examples.

In certain examples, transfer learning includes pooled transfer learning in which all prior user ratings of examples are used. In certain examples, transfer learning comprises same word transfer learning in which only those ratings are used that were made in the course of teaching a user concept with the same label as the first label.

In certain examples, prior user ratings are identified by placing a set of audio concepts in a vector space and determining a location within the vector space based on user's ratings of example. In certain examples a learning confidence value indicative of whether a meaning of the first audio concept has been learned is determined.

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components can be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, in at least one example, at least one of the elements is hereby expressly defined to include a tangible medium such as a memory, DVD, Blu-ray, CD, etc. storing the software and/or firmware.

### II. Overview

Virtually all sounds encountered in everyday life include energy across a wide range of frequencies. A common way to modify the timbre (e.g., tone) of a sound is to boost or cut the energy in restricted frequency ranges. A way in which energy is boosted or cut as a function of frequency is known as the Frequency Gain Curve (FGC). Technical expertise is required to determine the appropriate FGC, usually through an equalizer. Certain examples provide a procedure for enabling novice users to find their preferred FGC.

The FGC is among the most important parameters to consider when fitting a hearing aid. In practice a prescriptive FGC, derived from the audiogram, is initially applied. In a subsequent fine-tuning stage, the patient often communicates his or her concerns about the sound quality using descriptors (e.g., “it sounds hollow”), and the clinician modifies the FGC accordingly. Here, certain examples provide systems and methods that can enhance this process by rapidly mapping descriptors to FGC shapes. These methods and systems can also be used to examine an extent to which there is across-individual agreement in how descriptors map to FGC shapes.

In certain examples, hearing-aid fine tuning maps language-based descriptors to frequency-gain curves (FGCs). Listeners with hearing loss rate sound samples that vary in FGC characteristics according to how well the samples match common descriptors. Weighting functions are computed by evaluating a relationship between these ratings and gain values on a band-by-band basis. These functions are highly replicable despite variable ratings, reach asymptotic performance quickly, and are predictive of listener responses. While there are some global similarities about how descriptors mapped to FGC shape, there are also differences in the specifics of the mapping.

During experimental trials, a sound is processed by a probe FGC and then is played to the user. The user then rates how well that modified sound captured some concept in the user's mind (e.g., how “tinny” was this sound, how “clear” was this sound, . . . etc). The specific sounds and FGC curves can be tailored to the particular application (e.g., if the goal is to optimize speech intelligibility, then speech will be the sound). After several ratings have been collected, the procedure then attempts to determine the relationship between the ratings and the FGCs. In one potential instantiation, at each frequency a linear correlation is computed relating the probe FGC gains at that frequency to the user ratings. The slope of that line is computed at each frequency, and the series of those slopes is referred to as a weighting function. The user is then presented with a single controller that scales the weighting function to the desired extent. The scaled weighting function is the user's preferred FGC. The relationship between gains and ratings need not be a line, but can also take on a curvilinear shape, for example. Further, that relationship need not be computed on a frequency-by-frequency basis, and can be computed with a single procedure such as a multivariate linear regression. Finally, instead of relating gains to ratings, it is also possible to relate ratings to derivatives of those gains such as mel-frequency cepstral coefficients or the coefficients from a principle component analysis, for example.

For example, regression analyses can be conducted to determine a degree to which listener ratings are correlated with the gain values associated with each of twenty-five frequency-bands. An array of slopes of these regression lines across frequency-bands is referred to as the weighting function and is interpreted as the FGC shape that corresponds to the descriptor. This procedure is used to determine the FGC shapes associated with four of the most common descriptors used to describe hearing aid sound quality problems (“tinny”, “sharp”, “hollow” and “in a barrel, tunnel, or well”).

This weighting function shape is highly replicable despite variable listener responses, reached asymptotic performance quickly (e.g., 20-30 ratings), and is predictive of listener responses. As expected, on a global level, there is some agreement across individuals in how common descriptors map to weighting function shape. Over 95% of the variance in the weighting functions can be accounted for by two components: spectral tilt and middle frequency balance. However, considerable differences are observed between individuals in terms of the specifics of that mapping (e.g., slopes, cutoff frequencies, and whether the function was monotonic).

In certain examples, a descriptor-to-FGC mapping can be accomplished by determining individualized changes to the FGC. Given a range of individual differences in the specifics of descriptor-to-FGC mappings observed, this approach can be useful in a clinical setting to easily quantify these acoustic parameters. Implementation of such procedures can lead to more personalized fine-tuning of amplification devices, for example.

FGC determination can be applied in a plurality of domains. For example, FGC determination can be applied to music production. The procedure described above can enable a musician to modify a sound to achieve a particular character (e.g., “make the drums sound warmer”) without technical knowledge about how that character was achieved. Alternatively or in addition, FGC determination can be applied to hearing aid fitting. The procedure described above can be used to help hearing aid users modify the sound of their hearing aid to better suit their preference (e.g., “make the hearing aid sound less boomy”). This can be accomplished in the clinic as the hearing aid is being fit, or dynamically as the user enters a difficult listening situation, for example.

In certain examples, an algorithm that rapidly learns a listener's equalization preference on a case-by-case basis and still explores a wide range of settings is presented and evaluated. In this procedure, a relative weight that each portion of the audible frequency spectrum has on the perception of a given descriptor (e.g., “bright” or “warm”) is determined by correlating the gain at each frequency band with listener ratings. Thus, the relative perceptual importance of features of a stimulus is determined by the extent to which modifications to each feature are correlated to some perceptual variable.

In an example, an algorithm to rapidly learn a listener's desired equalization curve is described. First, a sound is modified by a series of equalization curves. After each modification, the listener indicates how well the current sound exemplifies a target sound descriptor (e.g., “warm”). After listener rating, a weighting function is computed where the weight of each channel (frequency band or region) is proportional to the slope of the regression line between listener responses and within-channel gain. Listeners report that sounds generated using this function capture their intended meaning of the descriptor. Machine ratings generated by computing the similarity of a given curve to the weighting function are highly correlated to listener responses, and asymptotic performance is reached after few (e.g., ˜20-30) listener ratings, for example. This approach can be used to generate a filter that alters the frequency spectrum of a sound as desired without direct manipulation of equalization controls.

Equalizers affect the timbre of a sound by boosting or cutting the level in specific regions of the frequency spectrum. These devices are widely used for many applications such as mixing and mastering music recordings. Equalizers often have interfaces that are daunting to the inexperienced user. Thus, such users typically describe the desired change to an experienced individual (e.g., an audio engineer) who performs the manipulation. This description can be a significant bottleneck if the engineer and the novice do not agree on the meaning of the words used. Indeed there is evidence that certain adjectives have different acoustical meanings across groups of users.

Additionally, for example, it appears that listeners from the US and the UK differ in how they use descriptors such as “warm” and “clear” to describe the sound of pipe organs. While listeners show considerable agreement on the equalizer correlates of some words (e.g., “tinny”), there is a wide range of variability on others (e.g., “warm”). Further complicating the use of a fixed descriptor-to-parameter mapping, the same parameter setting might lead to perception of different descriptors depending on the sound source. For example, a boost to midrange frequencies might “brighten” a sound with energy concentrated in the low frequencies (e.g., a bass guitar), but might make a more broadband sound (e.g., a piano) appear “tinny.”

The problem of across-individual descriptor variability can be mitigated if the user's preference is learned on a case-by-case basis. Procedures that learn the user's preference for audio processing on a case-by-case basis have been largely limited to setting the parameters of hearing aids and cochlear implants. Perhaps the most studied technique of this type is the modified simplex procedure. This approach requires the user make a series of paired comparisons differing in high- and low-frequency gain, and these judgments guide the search to converge on the desired setting. While this procedure can be relatively quick, the number of potential equalization curves explored is quite small. Although this procedure could theoretically be expanded to include more variables, the amount of time that this would take quickly becomes prohibitively large. Indeed most of the approaches that learn a user's preference on a case-by-case basis only explore a small range of parameter settings and, therefore, would probably not be sufficient for music production.

To circumvent this bottleneck, systems, methods, and apparatus are provided to rapidly learn a preferred equalization curve by computing a function based on the correlation between user ratings of a series of probe equalization curves and the gain at each frequency region. A user's preferences are learned on a case-by-case basis while still exploring a wide range of parameter settings. The underlying rationale is that the extent to which a particular feature influences the behavioral response will be reflected in the steepness and sign of the slope of a line correlating that feature to the same measure derived from the response (e.g., percent correct). With this in mind, the slope of the line fitted between the stimulus feature value and the behavioral response is computed for all stimulus features, and the combination of those slopes is called the weighting function.

Audio equalizers are perhaps the most common type of processing tool used in audio production. Equalizers affect the timbre and audibility of a sound by boosting or cutting the level in restricted regions of the frequency spectrum. Commercial equalizers often have complex interfaces. In an example, this interface is simplified by building a single personalized controller that manipulates all frequency bands simultaneous to allow a sound to be modified in terms of that descriptor.

Potential users of audio production software, such as audio equalizers, may be discouraged by the complexity of an associated interface and have a lack of understanding of conceptualized parameters in such an interface. Certain examples provide a personalized on-screen slider that allows a user to manipulate audio based on a descriptive term (e.g., “warm”), without the user needing to learn or use an equalizer interface. Certain examples learn mappings by presenting a sequence of sounds to the user and correlating a gain in each frequency band with the user's preference rating. Certain examples speed learning through a combination of active learning and transfer learning. Results on a study of 35 participants show how an effective, personalized audio manipulation tool can be automatically built after three ratings from the user, for example.

In certain examples, an audio production tool user interface is simplified and aligned with a user's conceptual model to enable quick and automatic personalization of the interface. Personalization occurs through a guided learning interaction in which the user teaches the system a concept. The system guides the learning with selective information requests (e.g., active learning) informed by previously learned concepts (e.g., transfer learning) and outputs a tool that allows the user to manipulate audio in terms of the user's concept. The following provides an overview of example base techniques followed by a description of example enhanced techniques utilizing active learning and/or transfer learning to accelerate and improve learning, categorization, and interface formation.

### III. An Example Base Technique for Listener-Based Audio Calibration

Audio production tools, such as equalization, reverberation and compression, are used to create professional quality music recordings in most genres of music, from Classical to Electronica, to Jazz. Equalizers, in particular, affect the timbre and audibility of a sound by boosting or cutting the amplitude in restricted regions of the frequency spectrum. An equalizer is one of the most widely used production tools. Therefore, equalization tools are used as an illustrative example herein.

Many equalizers have complex interfaces that lack clear affordances and are daunting to inexperienced users. This is because controls typically either reflect the design of preexisting analog tools or reflect the parameters of the algorithm used to manipulate the sound, rather than how sound is perceived. FIG. 18 shows an example interface 1800 for a parametric equalizer plugin. The example equalizer interface 1800 (e.g., a Kjaerhus© Audio Golden Equalizer) has 20 knobs, 9 push-buttons, and 18 radio-buttons. While a relationship between the interface 1800 and algorithms used to manipulate the sound is clear, a relationship between this interface 1800 and a typical user's conceptual model is not without training of the interface.

Currently, musicians who lack the technical knowledge to achieve a desired effect typically hire a professional recording engineer and verbally describe the desired effect. For example, the artist may say “I want it to start out ‘muffled’, like I'm playing through a closed door, then when the violin comes in, it goes ‘normal’ like the door just opened.” The engineer will interpret the description to create that effect, informed by past experience (e.g., Last time “muffled” meant “cut the high frequencies with the equalizer”, so I'll try that.). This approach can be expensive, since it requires paying a human expert by the hour. This approach is also limited by the musician's ability to convey a desired effect with language, the engineer's ability to translate that language into parametric changes, and the extent to which they agree on the acoustic correlates of the words used.

A better approach is to develop interfaces that let an artist directly control a device in terms of a desired perceptual effect. For example, the tool learns what “muffled” means to the artist, and then creates a knob that allows him or her to make a recording more or less “muffled,” bypassing a bottleneck of technical knowledge. Such an approach automatically adapts to the artist's work style, rather than forcing the artist to adapt to the tool, and can ultimately yield new technologies that support and enhance human creativity by allowing the artists to directly manipulate artifacts on their own terms.

In certain examples, a user selects an audio file and a descriptor (e.g., “warm” or “tinny”). The audio file is processed once with each of N probe equalization curves, making N examples. The user rates how well each example sound exemplifies the descriptor. A model of the descriptor is built, estimating the influence of each frequency band on user response by correlating user ratings with the variation in gain of each band over the set of examples. A controller (e.g., a slider) is provided to the user that controls filtering of the audio based on the learned model.

First, to modify the audio, a reference sound is passed through a bank of 40 bandpass filters (channels) with center frequencies spaced approximately evenly on a perceptual scale spanning the range of audible frequencies, and with bandwidths roughly equivalent to the critical band. Then, the sound is modified by adjusting the gain of each channel using a probe equalization curve. For this curve, the gain of each channel is determined by concatenating a set of Gaussian functions with random amplitudes from −20 to 20 dB, and random bandwidths from 5 to 20 channels, for example. Each probe curve in a set is selected to be maximally different from the preceding curves. After the gain is applied, the sound is reconstructed (e.g., the channels are summed) and played to the listener. To reduce or minimize an influence of loudness on user ratings, each presentation is scaled to have the same root-mean-squared (RMS) amplitude.

Each probe equalization curve is created by concatenating Gaussians functions in the space of the 40 channels, with random amplitudes ranging from −20 to 20 dB, and randomly chosen center channels and bandwidths, for example. Each curve is composed of between 2 and 8 Gaussians, each with a width of 5 to 20 channels.

To help ensure that the set of equalization curves has a wide range of within-channel gains, and a similar distribution of across-channel gains, a library of 5000 random probes is first computed. The initial probe equalization curve is randomly selected from the library. Once a curve is selected, it is removed from the library. Then, each subsequent probe was selected by choosing a member of the large population whose gain values were most different from the probes that preceded it. To help ensure a wide range of within-band gain values, and a similar distribution across bands, a probe that increased or maximized within-channel standard deviation of gains is chosen, after imposing a penalty for across-band distribution differences.

For each example used to train the system, the user hears the audio modified by a probe equalization curve. The listener indicates, such as by moving an on-screen slider, how well the modified sound exemplifies a user-determined descriptor (e.g., “warm” or “bright”). Ratings range from 10 (strongly representative) to −10 (strongly opposite), for example. Ratings could also range from −1 (very opposite) to 1 (very), for example. After 20-30 ratings, a linear regression is computed between the gain in each channel and the user rating. In an example, channels that strongly influence the perception of the descriptor are assumed to have steep regression slopes, while irrelevant channels will have shallow slopes. Therefore, the slope of the regression line for each channel is used as an estimate of the shape of the preferred filter. This is referred to as the weighting function.

Thus, high level language-based descriptors can be quickly mapped to audio processing parameters by correlating user-generated descriptor ratings to parameter values. This approach can be applied to an audio equalizer, etc.

In an example, fourteen listeners participated in an experiment. The average listener age was 29.4 years and the standard deviation was 8.5. All listeners reported normal hearing, and no prior diagnosis of a language or learning disorder. Eight of the listeners reported at least five years of experience playing a musical instrument, and four listeners reported at least four years of experience actively using audio equipment.

In the example, the stimuli were five short musical recordings. The sound sources were a saxophone, a female singer, a drum set, a piano, and an acoustic guitar. Each five second sound was recorded at a Chicago-area recording studio at a sampling rate of 44.1 kHz and bit depth of 16. To modify the spectrum, the sound was first passed through a bank of bandpass filters designed to mimic characteristics of the human peripheral auditory system. Each of the 40 bandpass filters (channels) was designed to have a bandwidth and shape similar to the auditory filter (e.g., critical band). The center frequencies were spaced approximately evenly on a perceptual scale from 20 Hz to 20 kHz. To remove any filter-specific time delay, the filtered sounds were time reversed, passed through the same filter, and time reversed again. Next, a gain value was applied to each channel according to a trial-specific probe equalization curve (e.g., a frequency vs. gain function, as discussed further below). Finally, the channels were summed and shaped by 100 ms on/off ramps. All stimuli were presented at the same root mean square (RMS) amplitude.

In the example experiment, listeners were seated in a quiet room with a computer that controlled the experiment and recorded listener responses. The stimuli were presented binaurally over headphones (e.g., Sony, MDR-7506) and listeners were allowed to adjust the overall sound level to a comfortable volume. Each listener participated in a single one-hour session. Within a session, listening trials were grouped into five runs, one for each stimulus/descriptor combination (e.g., saxophone/bright). The descriptors “bright”, “dark”, and “tinny” were each tested once, and the descriptor “warm” was tested twice. For all listeners, the descriptor “warm” was always tested with the recordings of the drum set, and the female singer. This pairing was chosen to examine listener and sound-source differences, for example. The remaining three descriptors were randomly assigned to the remaining recordings. The five runs were tested in a randomly determined order. There were 75 listening trials per run.

On each trial in the example experiment, the listener heard the stimulus modified by a probe equalization curve. The listener responded by moving an on-screen slider to indicate the extent to which the current sound exemplified the current descriptor (from −1: “very-opposite”, to 1: “very”). Once the listener settled on a slider position, they clicked a button to move on to the next trial. If the full 5-second sound had not finished playing, it was stopped when the button was clicked. To minimize the influence of the preceding stimulus, a 1 second silence was inserted between trials. Before each run, the entire unmodified sound was played to the listener as an example of a “neutral” sound (one which corresponded to the middle position on the slider).

For each listener in the example test, response consistency is estimated using the correlation coefficient (e.g., Pearson's r) between the responses to the identical probe equalization sets. To estimate the quality of the weighting function learned from user responses, the function is computed on one of the probe equalization sets and then tested on the remaining sets (the test set, multiple runs). For each probe equalization curve, a “machine response” is generated by measuring the correlation coefficient between the learned weighting function and each probe equalization curve. Then, the machine respons(es) are correlated with the user responses on the test set. Finally, the number of user responses for the weighting function to reach asymptotic performance is examined. The machine versus user correlation is computed as described above using the weighting function computed after each response. In summary, analyses indicate that listeners generate consistent weighting functions that are highly correlated to user responses, and that the weighting function can be learned after only ˜20 user responses, for example. Systems, methods, and apparatus can be used to create a tool that lets novice and expert users adjust an equalizer without the need to learn the user interface or directly adjust equalizer parameters.

FIG. 1 illustrates an example weighting function 140. For each channel, a gain on each trial 110 is correlated with an associated listener rating 115. Note that the same ratings are used for every channel 120, 121, 122. The regression line slope 130 is plotted for each channel center frequency 101-108 in the function 140, this function 140 is referred to as the weighting function. The displayed function 140 was obtained from a single listener on a stimulus/descriptor combination of drum set/warm.

In certain examples, listener evaluations of probe curves are used to compute a weighting function that represents the relative influence of each frequency channel on the descriptive word. Given N evaluations, there are N two-dimensional data points per channel. For each point, a gain applied to the channel forms an x-coordinate and a listener rating of how well the sound exemplified the descriptor is a y-coordinate (see, e.g., FIG. 1 A-C). An extent to which a channel influences the perception of the descriptor is reflected in the direction and steepness of the slope of a line fit to this data. Therefore, a slope of the regression line fit to each channel's data is computed. A single multivariate linear regression that simultaneously (or at least substantially simultaneously given a system, memory, processing, transmission, and/or other delay) relates all channels to the rating will not be meaningful in this situation because the gains in adjacent channels are highly correlated to each other, leading to the problem of multicollinearity.

In an example experiment, a weighting function describing the influence of each frequency channel on listener ratings was computed after all trials for a run were completed. For each channel, there were 75 data points, where the within channel gain was on the x-axis and the listener rating of how well the sound exemplified the descriptor was on the y-axis (e.g., 120-122 in FIG. 1). An extent to which a channel influences the perception of the descriptor will be reflected in the steepness of the slope of a line fit to this data set. A slope 130 of the regression line is computed fit to the data set for each channel. Examples of these regression lines are plotted for three channels in insets 120 through 122 of FIG. 1. The channels represented in insets 120 and 121 weigh heavily on the descriptor, albeit in opposite directions, while the channel represented in inset 122 has little weight on the descriptor. Following the terminology used in psychophysics, the array of regression line slopes across all channels will be referred to as the weighting function 140. In all cases the weighting function was normalized by the slope with the largest absolute value.

At the end of each run, the listener was presented with sounds that were modified by scaled versions of the weighting function. A new on-screen slider determined the extent to which the weighting function would be scaled, and a sound was played when the slider was released. The spectrum of that sound was shaped by the normalized weighting function multiplied by a value between −20 and 20, as determined by the position of the slider. This put the maximum point on the equalization curve in a range between −20 and 20 dB. The listeners were free to listen to as many examples as they wanted. Finally, the listener rated how well these modifications represented the descriptor that that they were rating, by moving the position of a new slider on screen where the left end was labeled “learned the opposite,” the middle was labeled “did not learn,” and the right was labeled “learned perfectly.”

In the example experiment, in order to get a good estimate of the weighting functions, the set of probe equalization curves has a wide range of within-channel gains, and a similar distribution of gains across channels. Before each run, a library of 1000 probe equalization curves is computed. Each probe equalization curve was created by concatenating Gaussian functions with random amplitudes from −20 to 20 dB, and with random bandwidths from 5 to 20 channels, for example. When the length of this vector was at least twice the total number of channels (80), concatenation ended. An array of 40 contiguous channels was randomly selected (thereby randomizing the center frequencies of the Gaussian functions) and stored as an element in the library. The probe equalization curve on the first trial was randomly selected from the library. Once a curve was selected, it was removed from the library. The subsequent probe curves are chosen to improve or maximize the across-channel mean of the within-channel standard deviation of gains after imposing a penalty for across-channel distribution differences.

In each run of the example experiment, there were 75 trials, divided into three sets of 25. Two of the sets included an identical set of 25 probe equalization curves. By comparing the two responses to the same curves, consistency in listener responses can be evaluated. The other third included a unique set of curves, which allowed for an examination of the extent to which the weighting function is influenced by the curves that were rated. The three sets of curves were tested in a random order in each run.

First, in the example, consistency in listener responses is assessed by comparing the two responses to the same probe equalization curve. In each run, twenty-five of the probe equalization curves were rated twice, allowing computation of a correlation between the first and second ratings of the same curve. A set of twenty-five probe curves was rated once. The three sets were presented to participants in random order. Across listeners, in sixty of the seventy (85%) total runs, the two sets of rating were significantly correlated to each other (p<0.05). The strength of that correlation was assessed by the correlation coefficient, Pearson's r, and the distribution of those values is displayed in the left box 210 of FIG. 2. The median correlation coefficient of 0.69 indicates that, in most cases, the descriptors had some meaning to the listeners, and that they were able to perform the task in a reliable manner.

To assess the quality of the weighting function, machine-generated ratings were compared to listener ratings 211, and also examined the listener's overall feedback 212. For each probe equalization curve, a “machine rating” was generated by assessing similarity to the weighting function using the correlation coefficient computed between the weighting function and each probe equalization curve. A correlation between the machine ratings and the listener ratings was then examined. The machine ratings were significantly correlated with the listener ratings for all seventy runs (p<0.05). The distribution of the correlation coefficients for all runs is plotted in the middle box of FIG. 2, and the median value is 0.72. The similarity between the machine vs. listener 211, and the listener vs. listener 210 correlation coefficients suggest that the weighting function captured much of the listener's meaning of the descriptor.

FIG. 2 demonstrates an example of weighting function quality. Each box plot represents results of the distribution of a statistic for 95 sound/descriptor pairs. In each box plot 210, 211, 212, the box includes lines at the upper 201, median 202, and lower 203 quartile values, and the whiskers extend to the max/min values 204, 205, or 1.5 times the interquartile range, for example. Outliers are removed from the plot. The box plot 210 on the left is the distribution of correlation coefficients when two responses from the same listener to the same probe equalization curve are correlated to each other (e.g., consistency). The middle box plot 211 is the distribution of machine vs. listener correlation coefficients (e.g., predictiveness). The right box plot 212 is the distribution of listener responses when rating the quality of the learned weighting function (e.g., feedback).

Once the weighting function was learned for each sound/descriptor pair, the listener was provided a slider to modify the sound, where the position of the slider determined the scaling of the weighting function, which was then applied as an equalization curve. After listeners heard sounds that were modified using the scaled versions of the weighting function, the listeners evaluated how well the weighting function learned their intended meaning from −1 (learned the opposite 231) to 1 (learned perfectly 230). The distribution of those values is plotted in the rightmost box plot 212 of FIG. 2. The median value was 0.73, again indicating that the weighting function captured the user's understanding of the descriptor.

Next, a number of listener responses required for the weighting function to reach asymptotic performance was examined. To accomplish this, the weighting function was computed after each of the 75 ratings obtained in the example. Using the same method described above, these weighting functions were used to generate machine ratings for all 75 trials, and those ratings were compared to the listener ratings. The distribution 301 of all machine versus listener correlation coefficients is plotted in FIG. 3 as a function of the number of responses used to generate the weighting function. The bottom of the grey area 302 indicates the 25th percentile, the top of the grey area 302 indicates the 75th percentile, and the black line 303 is the 50th percentile (the median). From visual inspection, it appears that the weighting function reached asymptotic performance at around 25 trials. However, the higher correlation coefficients appear to reach asymptote earlier (˜20 trials) than the lower correlation coefficients (˜30 trials).

FIG. 3 illustrates an example time course of learning. A weighting function was computed after each response and was then used to make a full set of machine ratings. Those machine ratings were correlated to user ratings. The shaded grey area 302 represents the 25th to 75th percentile and the solid black line 303 is the median correlation coefficient. It appears that the weighting function reaches asymptotic performance after ˜25 trials.

Next, in the example, an extent to which the specific set of probe equalization curves influenced the shape of weighting function was examined. For each run, weighting functions were computed on each subset of 25 trials. The similarity between weighting functions was assessed by computing the function versus function correlation coefficients. The distribution of those values 401 is plotted for functions computed on the same set of probe curves, but different listener ratings (FIG. 4 left 410, median r=0.92), and for functions computed on different sets of probe curves and different ratings (FIG. 4 right 411, median r=0.83). The correlation coefficients 401 were significantly higher for functions computed on the same 410, compared to different 411, sets of probe curves, as assed by a paired t-test computed after performing Fisher's r-to-z transformation (p<0.001). This difference indicates that the specific set of probe curves used has some influence on the shape of the resulting weighting function.

Thus, FIG. 4 demonstrates example specificity to probe curves. The box plots 410, 411 represent the distribution of function vs. function correlation coefficients 401 between weighting functions computed on the same (left) 410 or different (right) 411 sets of probe equalization curves, with *p<0.001.

Thus, certain examples provide efficient and effective learning and customization of an individual's subjective preference for an equalization curve. On average, listeners indicated that the weighting function was successful in capturing their intended meaning of a given descriptor. Listener ratings are well predicted by the similarity between a given probe curve and the computed weighting function. Further, the algorithm reached asymptotic performance quickly, after only ˜25 trials.

One limitation of the current algorithm is that the shape of the weighting functions is partially influenced by the choice of probe equalization curves. The weighting functions generated by the same set of probe curves were more similar to each other than those generated with a completely different set of probe curves (see, e.g., FIG. 4). The influence of the set of probe equalization curves was possibly due to the fact that the gains were highly correlated across adjacent channels (by definition, the Gaussian functions used to generate the probe curves had bandwidths between 5 and 20 channels).

To illustrate this idea, for example, consider two hypothetical channels adjacent to each other in a weighting function, where one of the channels does not contribute to the perception of a descriptor, but the other does. If the specific probe curves chosen tend to modify the gain of both channels in the same direction, the channel that does not contribute to perception of the descriptor will have a steep slope. However, as the variability in the set of probe curves increases (e.g., as the number of trials increases), the size of this artifact may decrease.

An alternative approach uses probe curves where the gain is set randomly on a channel-by-channel basis. However, pilot experiments using random probe curves indicate that the number of frequency channels should be quite small to yield a meaningful weighting function.

Additionally, certain examples provide a useful tool in a recording studio for situations such as where a novice knows the sound of spectral modification that he/she desires, but is unable to express it in language. An equalizer plug-in can generate probe curves to be rated by the novice, and the plug-in returns a weighting function that can then be scaled to the desired extent. In the example experiment described above, the median trial duration was 3.7 seconds and asymptotic performance was reached in approximately 25 trials, so a high quality weighting function could be generated in under two minutes. Examples can also be useful for experienced users who prefer to avoid directly adjusting equalizer parameters. Examples can also be useful in calibrating hearing aids and/or other speaker devices for particular user limitations, preferences, etc. (e.g., according to a user's preferred frequency-gain curve in hearing aid fitting).

Musicians often think about sound in terms that, while they may be well-defined for the individual or a group, do not have known mappings onto the controls of existing audio production tools. Further, many do not have the technical expertise or time to explore the existing parameters to achieve the desired perceptual effect. Certain example systems and methods described herein seek to bridge the gap between the user's concept and the processing tool's controls. Certain examples quickly and automatically map individual subjective sound descriptors onto processing parameters, by correlating user ratings to parameters values.

In certain examples, the weighting function shape can be examined on an individual level to evaluate how the weighting function shape differed across each of four tested descriptors. The left column of FIG. 5 represents an example audiogram, and the other columns indicate the weighting functions for each of the four descriptors, labeled at the top (e.g., “hollow,” “in a barrel/tunnel/well”, “sharp”, “tinny”). In the weighting function plots, the squares along the line represent the across-run average weight associated with each frequency band, and the error bars represent one standard error of that mean. On a global level, FIG. 5 shows a fair amount of across-individual agreement. The descriptors “hollow” and “In a barrel/tunnel/well” tend to be associated with negatively sloping spectral tilts, while the reverse is true for the descriptors “tinny” and “sharp.” The similarity between these pairs of descriptors is the likely source of the frequent within-pair confusions observed in the matching task. However, these curves in the example of FIG. 5 do show considerable and consistent within-descriptor variation across individuals in terms of the specific slopes, cutoff frequencies, and whether the function is monotonic. For example, for listener 1, “tinny” was a gradual positively sloping change to frequencies >0.5 kHz (FIG. 5, top row, right column), while for listener 4 it was a steep positive slope starting from about 0.5 to 1 kHz, and a gradual negative slope at higher frequencies (FIG. 5, fourth row, right column). It is noteworthy that the error bars within each panel are typically small. As described earlier, this implies that across-individual differences in weighting function shape are due to individual differences in descriptor-to-FGC mappings rather than measurement error.

Next, to systematically analyze these individual differences, the dimensionality of an example set of 120 weighting functions can be reduced. Principal Component Analysis can be used to determine how well the entire set of weighting functions could be described as a linear combination of a small number of component weighting functions. The first component (a spectral tilt, FIG. 6A) accounts for 78.4% of the (r-squared) variance in the weighting functions. When a second component is added (a modification to the middle frequency balance, FIG. 6B), the two components account for a combined 95.6% of the variance. Beyond these two components, there is only a marginal improvement when additional components are added.

In the example, each of the 120 weighting functions can be described by two parameters: a score associated with each of the two components. The values of these two scores for each weighting function are plotted in FIG. 6C. The left/right position of the point represents the score associated with the first principal component, and the up/down position represents the score associated with the second principal component. The symbol indicates the descriptor that was rated and the size of the symbol indicates the predictiveness associated with that function. The shape of the weighting function associated with locations in this space is plotted in FIG. 6D. In general, the “hollow” and “in a barrel/tunnel/well” weighting functions are on the left side of the graph, indicating a negative spectral tilt, while the opposite is true for the “tinny” and “sharp” weighting functions. This observation is consistent with idea there are global similarities in weighting function mapping across listeners. However, there does not appear to be any regularity in how the points are distributed across the vertical dimension (the second principal component), which is consistent with the idea that the specifics of the descriptor-to-weighting function mapping is idiosyncratic.

Finally, it does not appear that individual differences in weighting function shape have a strong relationship to the shape of the audiogram itself, likely because a prescriptive fit can be applied before adding any probe FGC. To evaluate whether there is an influence of the listener's hearing loss on the shape of the weighting function beyond what is initially accounted for by the prescriptive fit, the pure-tone threshold at each measured frequency was correlated with the absolute value of the average weight at that frequency for each listener/descriptor combination. As shown in this example, a slight, but significant, correlation may exist between threshold and weight (r=−0.17; p=0.01). This correlation indicates that there was a slight tendency in the example data set to give a lower weight to frequencies where hearing threshold was poorer. However, this correlation might simply reflect that low-frequency bands are weighted more highly than high-frequency bands, regardless of hearing loss. In the example group of individuals with hearing loss, the absolute value of the weights for bands below 1 kHz was 32% higher than those above. Individuals with normal hearing showed a similar trend over the same frequency range, weighting low frequency bands 26% higher than high frequency bands. Further, correlation between summary statistics of the weighting function and audiogram summary statistics can be examined. In the example data set, there appears to be no significant correlation between the weighting function and the audiogram in terms of the absolute value of the overall slope (r=−0.06, p=0.73), the maximum slopes between frequency bands (r=−0.13, p=0.41), or spectral centroids (r=−0.09, p=0.59). Taken together, after applying a prescriptive fit based on the audiogram, there appears to be little, if any, additional influence of the audiogram in the descriptor-to-weighting function mapping.

Example systems and methods are described and evaluated herein for mapping descriptors to FGC shape by correlating descriptor ratings to gain on a frequency-band by frequency-band basis. Using these methods, systems, and apparatus, FGC shape associated with common descriptors in a group of individuals with hearing loss can be estimated. While there is some global agreement between individuals in the mapping of these descriptors to FGC shape, there is also considerable individual variability in the specifics of that mapping.

In certain examples, procedural and/or cognitive differences can potentially account for across population consistency differences. On the cognitive level, it is possible that in individuals with hearing loss, the internal representation of the sound samples is degraded, placing a greater strain on cognitive processes such as working memory during the rating task. It appears that an ability to make reliable comparisons between hearing aid parameter settings is related to the working memory capacity of the patient. In certain examples, a procedure that allows the patient to make side-by-side comparisons between FGCs (rather than a serial rating procedure) may place less of a strain on working memory and ultimately lead to more consistent responses. Despite variability in listener ratings, the shape of the weighting function is consistent across test runs. Consistency in weighting function shape may reflect that the number of trials needed to create a meaningful weighting function is quite small when responses are consistent, but, when responses are more variable, additional trials are needed to average out the noise and create a meaningful weighting function. This robustness to listener variability makes this procedure valuable in a clinic, for example.

In certain examples, a weighting-function based method and associated system address some of the issues associated with non-descriptor based fine-tuning procedures. First, most of the previous methods for non-descriptor based fine-tuning split the FGC into only 2 or 3 frequency channels and search for the best gain values for those channels. In an example weighting function procedure described herein, weights are given to each of 25 frequency bands, thereby exploring a much wider range of possible FGC shapes. Second, several of the previous methods are adaptive, gradually approaching the desired FGC, and in such methods, the final FGC is highly dependent upon the initial FGC. Since certain example methods described herein are not adaptive, these methods are not subject to this problem.

Certain examples can be applied to hearing aid users. Certain examples can be applied clinically to give a patient more control of his or her hearing aid in an intuitive way to improve patient satisfaction.

Certain examples could be used to compute a weighting function for a patient-generated descriptor during a fine-tuning stage. A clinician can present a patient with probe FGCs, and the patient can rate how well each probe FGC captured the meaning of the descriptor. The weighting function, which can be measured in minutes, for example, reflects a relative influence of each frequency band on that descriptor. Once the weighting function is measured, the clinician can present the patient with a new slider that scales the actual gain values of each frequency band in proportion to its weight. This effectively creates a slider that is tuned to the descriptor (e.g., a “sharp” slider). The patient can then move that slider to the appropriate position. Further, a patient's preferred hearing aid settings can vary with the particular listening environment. Thus, another example allows the patient to conduct the weighting function measurement procedure outside of the clinic if the weighting function measurement procedure is incorporated into a trainable hearing aid.

An alternative example allows a user to modify sound using space defined by the principal components (see FIG. 6D). The two principal components displayed in FIG. 6A-B can account for more 95% of the variance in the weighting function shapes observed. If these weighting functions are representative of an entire population of weighting functions across different patients and descriptors, then this representation can provide the user with a simple way to modify his or her own FGC. In one alternative, an interface is provided to adjust the weight given to these acoustic parameters, for example, by modifying the FGC within the two-dimensional space of the principle components. An example interface allows the listener to drag a dot in a box, where the horizontal position of the dot alters the weight of principle component 1, and the vertical position alters the weight of principle component 2. As the dot is dragged to the right, the sound becomes more tinny/sharp and as the dot is dragged to the left, the sound becomes more hollow (e.g., as if it were a barrel, tunnel, or well). Similar to the effect of starting slider position described above, this interface can be influenced by the starting position of the dot. The interface can be used by patients outside of a clinic with advances in trainable hearing aids in order to adjust the FGC to adapt to the specific listening environment, for example.

Thus, certain systems and methods described herein determine a relationship between subjective descriptors and FGCs for an individual. Fine tuning procedures can be improved by accounting for individual differences in descriptor-to-parameter mapping.

Additionally, in certain examples, fine tuning can be applied to combinations of audio manipulators. Certain examples provide refinement of controller parameters in non-monotonic space. Additionally, as the number of users of these audio production tools increase, patterns are expected to form in the descriptors they choose to train the tools to manipulate. For example, many users may choose to define “warmth” as an audio descriptor, while few users might select “buttery.” Commonalities and differences in chosen concepts and their mappings can help provide insight into the concepts that form a basis of musical creativity in individuals and within communities. An automatic synonym map can be formed based on commonalities between controller mappings (e.g. one person's “bright” may be other person's “tinny”).

FIGS. 7-9 provide example interfaces 700, 800, 900 used for training, verification, and feedback. As shown, for example, in the training interface 700, a user/listener, when presented with a sound, provides feedback by moving a slider 710 to indicate whether a provided word or qualifier 720 matches the sound heard. Using the verification interface 800, a listener can verify that the machine learned their sound preference. For example, by moving a slider 810, the user can make/change a sound being played according to the provided word 820. Using the example interface 900, a user can provide feedback via a slider 910 to let the machine know how well the system learned user preference.

Using training, generalization, and/or validation trials, a particular filter (e.g., a function that turns up or down various frequency bands according to the shape of the Gaussian mixture described above) can be manually and/or electronically selected, applied to a sound, and rated by a user. By performing a plurality of trials and comparing user responses and computer responses, a determination of an effect of the trials on computer response can be determined.

Using the shape of a mixture of Gaussian function across frequency, the frequency spectrum can be manipulated (e.g. turn up the bass, turn town the treble, etc) in a systematic way. Alternatively, the frequency spectrum can be modified with a line, a sinusoid, a quadratic, etc. At each frequency, the gain (e.g., an amount of boost or cut) is correlated with the response for all trials. The Gaussian function, for example, is used to determine the gain. A relationship between gains and user ratings is fit to a line, a curvilinear shape, etc., to indicate a user's preferred frequency gain curve in the form of a scaled weighting function, for example.

FIG. 10 provides a plurality of example weighting functions for “warm,” “bright,” “dark,” and “tinny” sounds as used herein based on normalized slope and frequency (Hz). FIG. 11 summarizes an example simulation of machine ratings generated by computing the similarity of a given probe to the weighting function based on user ratings. Specific probe curves used to “train” example systems, methods, and/or apparatus can influence the shape of the resulting weighting function, for example.

FIG. 12 illustrates an example interface of an application 1200 that easily allows sound adjustments to be made on digital audio equalizers. Both amateurs and professionals can use the application 1200 to manipulate sound in a way that automatically matches a listener's desired modification in a short amount of time. Audio equalizers affect the timbre and audibility of a sound, and each listener may have a different preference and may use different terminology to describe a particular sound modification. What is “tinny” or “warm” to one person may not be to another. In fact, studies have shown that listeners apply the word “warm” in very different ways. The application 1200 deals with this discrepancy by learning what equalizer curve best matches each listener's vocabulary.

The application 1200 can be implemented as a pop-up window, dialog box, standalone graphical user interface (GUI), etc., integrated into an audio application or implemented as a separate utility. In one example, the application interface 1200 is integrated into a commercially available digital audio equalizer. The application 1200 is activated by clicking a button opening a pop-up window from the digital equalizer interface. The application 1200 begins by mapping a word to an equalizer curve shape. Using a simple interface, the listener types in a word to be mapped (e.g. “warm,” “bright,” “dark”). A small number of sound samples are presented (such as by selecting a button 1210), and the listener indicates how well the word describes each sound sample (e.g., using a slider 1230 along a range or scale of values or other such indicator). Behind the scenes, the application 1200 determines the equalization curve 1240 that best fits the user's ratings. Once this process is complete, the listener is presented with a slider 1230 that corresponds to the word they entered (see FIG. 12). When the user has finished calibrating a sound, the user can select a button 1220 to complete calibration and/or advance to the next sound, for example. The application 1200 benefits amateurs who may not understand how to use complex equalizers, and it provides an easier way for professionals to alter sounds to match a particular client's verbal descriptions.

FIG. 13 illustrates an example calibration system 1300 to calibrate a device based on learned user preference. The system includes a processing subsystem 1310 including a graphical user interface (GUI) 1320 connected to a speaker 1330. The processing subsystem 1310 is also connected to an electronic device 1340 producing sound for a user. In some examples, the GUI 1320 can be implemented separate from the processing subsystem 1310. The processing subsystem 1310 can be implemented as a personal computer, workstation, mainframe, server, handheld or mobile computing device, embedded circuit, ASIC, and/or other processor, for example. In some examples, the speaker 1330 can include a microphone to accept audio input. The components of the system 1300 can be implemented in a variety of combinations of hardware, software, and/or firmware. The components of the system 1300 can communicate via wired and/or wireless connection(s), for example.

In operation, a user launches a test application on the processing subsystem 1310 via the GUI 1320 after the device 1340 and the speaker 1330 have been connected to the processing subsystem 1310. A listener interacts with the test application via the GUI 1320 as discussed above, such as with respect to FIGS. 1-12. Based on user feedback in training and validation based on sound transmitted by the processing subsystem 1310 through the speaker 1330 and feedback received from the listener through the GUI 1320 (and/or other input), the processing subsystem 1310 can determine a preferred frequency gain curve and corresponding weighting function for that listener. As discussed above, the FGC and weighting function can be used to program the device 1340 (e.g., a hearing aid, equalizer, etc.) for operation tailored to the particular listener's preference/condition.

FIG. 14 illustrates a flow diagram for a method 1400 for listener-based audio calibration. FIG. 14 depicts an example flow diagram representative of processes that can be implemented using, for example, computer readable instructions that can be used to facilitate listener calibration and audio output. The example processes of FIG. 14 can be performed using a processor, a controller and/or any other suitable processing device. For example, the example processes of FIG. 14 can be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example processes of FIG. 14 can be implemented using coded instructions (e.g., computer readable instructions) stored on a non-transitory computer readable medium such as a flash memory, a read-only memory (ROM), a random-access memory (RAM), a CD, a DVD, a Blu-ray, a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example processes of FIG. 14 can be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIG. 14 can be implemented manually or as any combination(s) of any of the foregoing techniques, for example, any combination of firmware, software, discrete logic and/or hardware. Further, although the example processes of FIG. 14 are described with reference to the flow diagram of FIG. 14, other methods of implementing the processes of FIG. 14 may be employed. For example, the order of execution of the blocks can be changed, and/or some of the blocks described may be changed, eliminated, sub-divided, or combined. Additionally, any or all of the example processes of FIG. 14 can be performed sequentially and/or in parallel by, for example, separate processing threads, processors, devices, discrete logic, circuits, etc.

FIG. 14 illustrates an example flow diagram for a method 1400 for listener calibration using an equalization curve. At 1410, a reference sound is modified by a series of equalization curves. At 1420, after each modification, the listener indicates how well the filtered sound exemplifies a target sound descriptor (e.g., “warm,” “dark,” “tinny,” etc.). At 1430, a weighting function is generated, where gain in each channel (e.g., frequency region) is proportional to a slope of the regression line between user responses and gain within the channel (e.g., within-channel gain). At 1440, a filter is generated based on the weighting function to alter the frequency spectrum of a sound as desired without direct manipulation of equalization controls. Such a filter can be applied to a music equalizer, a hearing aid, etc.

In further detail, at 1410, the reference sound is modified by adjusting the gain of each frequency band using a probe equalization curve (e.g., by using a single filter or bank of bandpass filters). For this curve, the gain of each channel is determined by concatenating a set of Gaussian functions with random amplitudes and random bandwidths. Each probe curve in a set is selected to be maximally different from the preceding curves.

At 1420, after the gain is applied, the sound is reconstructed and played to the listener. The listener provides feedback, such as by moving an on-screen slider, to indicate how well the modified sound exemplifies a user-determined descriptor (e.g., “warm” or “‘bright”’).

At 1430, after a series of listener ratings, a linear regression between the gain in each channel and the user rating is computed. A slope of the regression line for each channel is used as an estimate of the shape of the preferred filter, referred to as a weighting function. At 1440, a filter corresponding to the weighted function is generated and provided to modify sound(s) according to listener feedback. At 1450, the filter is applied to the audio. For example, the filter is applied to adjust a hearing aid setting, an audio equalizer, and the like.

### IV. Example Applications of Transfer Learning and/or Active Learning to Listener-Based Audio Customization

While examples provided above illustrate certain approaches to listener-based audio calibration, additional improvements can be provided. For example, an effective way to accelerate concept learning is through reuse of data from previously learned concepts (referred to, for example, as transfer learning). Data reuse can be guided by selective information requests (referred to, for example, as active learning). As more and more users train the system, transfer learning can increasingly be used to reduce a number of questions to build an acceptable controller for new users. When presented with a new user, a concept learner can achieve good results by asking only a few questions to locate the user's desired concept (e.g. make my hearing aid “not tinny”) in a space defined by previous user-concepts, even if that user has never been presented to the learner before. Once the user's concept is located in the space, previous training data can be used to inform the learning of the current concept.

Certain examples leverage an intuition or assumption that another user's concept may be similar to the current concept, even if the users have different labels (e.g., Bob uses a label of “warm” for a certain sound, and Maria uses a label of “not tinny” for the same sound). When teaching the system two concepts, similarity between the two concepts can be estimated by determining how similar user responses were to the same set of examples. In certain examples, the more similar the set of responses, the more similar the concepts, and the more relevant the prior responses are to learning the current concept.

A. Applying Transfer Learning

Transfer learning makes use of data from previously learned tasks. A combination of active and transfer learning quickly places a current user in a space of prior users that have taught concepts to the system. Learning can be speeded by applying data from prior user-concepts to a current problem. Rather than customizing a set of widgets or controls, certain examples personalize “under-the-hood” parameters that are adjusted by an existing interface element based on learned natural language concepts.

In certain examples, to apply transfer learning, a fixed question set of examples, called M, is created by manipulating a standard audio file (e.g. a 5 second passage from Delibes' Flower Duet) in different ways using a tool, such as an equalizer. A typical size for M is 50 manipulated examples. For each of n users, the user is to select a concept (e.g., concepts vary by user) and rate examples in M on a continuous scale (e.g., −1 to 1) based on how well each example conforms to that user's chosen concept. The concept rating creates a set of prior knowledge to use in transfer learning.

In certain examples, a user-concept is defined as a concept (e.g., concepts are sound adjectives) taught to a machine by a particular user (e.g., Bob's concept for “warm” sound). If two users teach the system the same word, then there are two user-concepts (e.g., Bob's “warm” and Tolga's “warm”). With equalization, two user-concepts results in two equalization curves (also referred to herein as “frequency gain curves” or “weighting functions”).

While each user is unique, user-concepts may be related, even when they do not share a label. FIG. 15 shows learned equalization curves for three user-concepts. As shown in the example of FIG. 15, equalization curve c) for User 2's “Bright” is more similar to equalization curve b) for User 1's “Tinny” than it is to equalization curve a) for User 1's “Bright”. If a prior user-concept is similar to the current user-concept, then user responses to training examples for the prior concept may help in learning the current user-concept, even if the two do not share a label.

In the absence of active learning and transfer learning, a user-concept is taught to the system by rating the example set M, as described above with respect to FIG. 14. FIG. 16 illustrates a pool 1610 of rated examples for three user-concepts: warm 1612, dark 1614, and phat 1616.

In the example of FIG. 16, an audio file 1605 is manipulated with m equalization curves 1620 to create m examples. Each user rates 1630 examples in terms of a particular adjective 1610 (e.g., how “warm” is this example on a scale from −1 to 1).

For transfer learning, an existing set of user-concepts is translated into a vector space. Let Q be a subset drawn from the set M of examples rated by users. Each user-concept's location is determined by that user's ratings of the examples in Q when training the system on a concept. FIG. 17 shows the user-concepts 1612-1616 from FIG. 16 in a space (e.g., a two-dimensional space) defined by user ratings of examples 2 and 3 1710, 1720 (e.g., second and third example manipulations) from FIG. 16.

When training a system on a new user-concept, rather than asking a user to rate a full set of M examples, the user is asked to only rate a subset Q of the M examples, placing the new user-concept in vector space. Rather than asking the user to rate the remaining examples in M, the system estimates the user's ratings of these examples by taking a weighted combination of user responses to these examples for past concepts. Weight given to the responses for a prior user-concept is determined by a distance between the prior user-concept and the current user-concept in the vector space. The estimated ratings are used in a concept training procedure for the new user's concept. Properly done, the weighted estimation can greatly lessen a number of examples a typical user must rate before an effective controller can be learned. For example, the number of examples can be reduced by a factor of 10.

B. Applying Active Learning

Active learning refers to several similar but distinct concepts across disciplines. In certain examples, active learning includes a machine learning approach in which the machine selects a set of examples on which to receive training data, rather than passively receiving examples chosen by the teacher. Machine learning can improve learning by letting the machine select examples the machine believes will be most helpful for learning.

In certain examples, active learning can be used to address a question regarding which subset (e.g., Q) of the examples in M can best locate the current user-concept in the space of prior learned user-concepts. In certain examples, a query-by-committee variant can be applied.

For example, given a user and a concept, the system presents example manipulations of an audio file to be rated by the user. Given a pool of prior user-concepts, where all users rate the same set M of audio examples, one can measure the variance of responses for each example across all prior users. An audio manipulation with high variance among user responses is a promising query, since the wide spread of responses makes it easier to distinguish which existing user-concepts (e.g. Bob's “tinny”) are closest to the new concept the system is attempting to learn. A good subset of the examples in M to present as the query set, Q, therefore, is the set of examples that showed high variance in user responses.

Referring to FIG. 16, assuming that a goal is to select which of the three user-concepts is most like a new user-concept by asking the user to rate 1630 a single example. The example in the top row of FIG. 16 generated responses that were in broad agreement: all positive, with a low variance among ratings. The second row shows a set of responses that range from positive to negative, with a large variance. Asking the user to rate the example that generates disagreement between concepts provides much more information.

On each trial of active learning, a new probe curve q is selected to add to the query set Q, and the probe q is presented to the user. A curve selected is the one with the highest estimated variance for user v. Only the most relevant and informative examples are to be presented to the user, for example.

Certain examples provide adaptive creativity support tools that conform to an artist's conceptual ideals essentially brings a user-centered design approach to construction of a user interface. Certain examples automatically map individual human audio concepts onto acoustic features—a process that can be substantially sped up and improved through the use of active learning and transfer learning. Resulting controllers can meaningfully change sounds in terms of the audio concepts the machine is taught, for example.

Equalizers are widely used for mixing and mastering audio recordings. Audio equalizers also provide an opportunity to rethink an approach to building a software audio tool interface. Rather than use a single interface for all users, based on past hardware design, certain examples enable an approach to building a personalized interface for each user. Certain examples facilitate creation of a controller whose interface is conceptualized in descriptive terms defined by the user.

In certain examples, an audio concept learner enables a user to select an audio file and a descriptor (e.g., “warm”, “tinny”, etc.). The selected audio file is processed once with each of N probe equalization curves (e.g., N 40-band probe equalization curves), making N examples. Then, the user rates how well each example sound exemplifies the descriptor (see, e.g., FIG. 20). User rating can be affected by applying active learning to select examples for user review that resulted in a largest variance in ratings given by prior users. A model of the descriptor is built, estimating an effect of each frequency band based on user response by correlating user ratings with a variation in gain of each band over a set of examples. Through transfer learning, a user's ratings of examples can also be correlated and/or otherwise combined with prior user ratings of examples that the particular user has not yet rated. A slope of a resulting regression line for each frequency band indicates a relative boost or cut for that frequency (see, e.g., FIG. 21). As shown in the example of FIG. 21, a learned equalization (EQ) curve is provided for a single user's concept of “warm.” The vertical axis indicates a relative boost or cut in amplitude at a given frequency. The boost or cut at each frequency corresponds to a slope of a regression line between user ratings and the boost/cut in that frequency on the set of examples that a user rated. The system presents to the user a personalized controller (see, e.g., the controller 1900 of FIG. 19) that controls filtering of the audio based on a learned model of how to manipulate audio.

As shown in FIG. 19, the controller 1900 provides a slider 1910 for the user to characterize or evaluate a sound and process 1920 the audio accordingly. The example controller 1900 is constructed for a user to adjust “tinny” sounds, for example.

The approach of FIG. 20 typically asks the user 2005 to rate 2020 roughly 20-25 audio examples 2010 to generate an acceptable controller. While 25 interactions may be acceptable to some, many users do not have the patience for this number of ratings. Therefore, in certain examples, a speed of learning is increased such that a good controller can be learned from approximately less than five user ratings of audio examples. This reduction in interactions is accomplished through reuse of data from prior users and concepts (e.g., transfer learning). If the machine is judicious in selecting audio examples to present to the user (e.g., active learning), learning can be sped up further.

When transfer learning is employed, as more and more users train the system, a number of questions to build an acceptable controller for new users can be reduced. When presented with a new verbal concept (e.g., ‘dark’), the concept learner may be able to achieve good results by asking only a few questions to locate the user's concept in a space defined by previous concepts, even if that word has never been presented to the learner before. Once the concept is located in the space, previous training data can be used to inform the learning of the current concept, even if that particular descriptive has never been presented to the system before.

The intuition here is that another user's concept may be similar to the current concept, even if they have different labels. A similarity between two concepts can be estimated by determining how similar user responses are to the same set of examples, when teaching the system those concepts. Presumably, the more similar the set of ratings, the more similar the concepts and, therefore, the more relevant the prior ratings are to learning the current concept.

C. Distance and Weighting

As discussed above, a user-concept is a concept for a particular word for a particular user, such as “Bob's concept for ‘warm.’” Given a new user-concept (e.g., Maria's ‘dark’), the user (e.g., Maria) rates examples in a query set Q. The user's ratings for the remaining M-Q examples are estimated using a weighted combination of past user ratings for previous user-concepts, for example. Suppose U represents a set of prior user-concepts, for which users have each rated all the examples in M. Assuming that a weight for a prior user-concept u should go down as a distance between u and a new user-concept v increases, the more similar the prior user's ratings were to the current user's ratings of examples, the more influence the prior user-concept has on how the system learns the new user-concept.

Having no strong a priori justification for what distance metric to use, a generalized p-norm distance metric, described in Equation 1, is considered. Here, in one example, when the value p=1, the distance metric is Manhattan; for p=2, the distance metric is Euclidean.

$${d}_{n} ( u , v ) = {[ {\sum }_{q ∈ Q} {\vert {r}_{u} ( q ) - {r}_{v} ( q ) \vert}^{p} ]}^{1 / p} . \qquad Equation ( 1 )$$

In Equation 1, rᵤ(q) is a rating given to example q for user-concept u, and rᵥ(q) is a rating given to example q for user-concept v. Each rating falls in a range (−1,1). In certain examples, Equation (1) can be re-written as:

$$d ( u , v ) = ( {\sum }_{q ∈ Q} \vert {r}_{u} ( q ) - {r}_{v} ( q ) ) \vert . \qquad Equation ( 2 )$$

A weight of user-concept u is determined by distance as follows.

$$w ( u ) = \frac{φ ( {d}_{n} ( u , v ) )}{{\sum }_{k ∈ U} φ ( {d}_{n} ( k , v ) )} . \qquad Equation ( 3 )$$

Equation (3) represents a weight given to a user according to a mapping function (φ). While a variety of mapping functions and p-norms can be used, a Manhattan distance with a Normal mapping shown in Equation (4) is used as one example for purposes of illustration.

φ_{Normal}(x)=exp(−2x²) Equation (4).

In some examples, the Normal mapping results in a revised Equation (5):

$$w ( u ) = \frac{exp ( - 2 {d ( u , v )}^{2} )}{{\sum }_{k ∈ U} exp ( - 2 {d ( k , v )}^{2} )} . \qquad Equation ( 5 )$$

Given a set U of prior user-concept that have been placed in a vector space as described earlier, an estimated rating that the new user will give to an un-rated example q is provided using a weighted sum of prior user-concept ratings for that example (Equation 6).

$${\tilde{r}}_{v} ( q ) = {\sum }_{u ∈ U} w ( u ) \cdot {r}_{u} ( q ) . \qquad Equation ( 6 )$$

D. Pooled Transfer Learning

In certain examples, transfer learning does not restrict a pool of prior data either in terms of user or in terms of what concept the user was attempting to teach the system. All prior learned data from all users and all concepts can be employed (referred to as a Pooled Transfer Learning approach). A previous user-concept (Sally's “bright”) may be similar to the current concept (Bob's “tinny”), even if they have different labels. Therefore, data from previous concepts can inform learning of new concepts with different labels.

E. Same-Word Transfer Learning

A second approach, called Same-word Transfer Learning, applies transfer learning only to data collected from other users training the system on the same concept word that the current user is teaching the system. For example, only the example ratings from prior users on the word “warm” are included when learning a “warm” controller for a new user. In cases where there is a subset of users with a shared concept for a word, the Same-word Transfer Learning method may work better.

F. Combining Active Learning and Transfer Learning

In certain examples, a subset (e.g., Q) of examples in M is selected to locate a current user-concept in a space of prior learned user-concepts using active learning. For example, a query-by-committee variant can be applied.

Given a user and a concept, the system presents example manipulations of an audio file to be rated by the user. Given a pool of prior user-concepts, where all users rate the same set M of audio examples, one can measure the variance of responses for each example across all prior users. An audio manipulation with high variance among user responses is a promising query, since the wide spread of responses makes it easier to distinguish which existing user-concepts (e.g., Bob's “tinny”) are closest to the new concept the system is attempting to learn. A good subset of the examples in M to present as the query set Q, therefore, is the set of examples that showed high variance in user responses.

Considering FIG. 16, the user is asked to rate a single example with a goal to select which of three user-concepts is most like a new user-concept. The example in the top row generated responses that were in broad agreement: all positive, with a low variance among ratings. The second row shows a set of responses that range from positive to negative, with a large variance. Asking the user to rate the example that generates disagreement between concepts provides more information.

On each trial of active learning, a new probe q is selected to add to the query set Q and presented to user v. A curve selected is one with a highest estimated variance for user v.

As discussed above, FIG. 13 illustrates an example system 1300 to facilitate personalization of an audio equalizer interface with transfer learning and active learning. The example system 1300 can be used to facilitate personalization based on transfer learning and/or active learning. The processing subsystem 1310 (e.g., a computer such as a desktop computer, laptop computer, tablet computer, smartphone, etc.) generates an audio output via the speaker or other audio output 1330 and receives input from a user via one or more input devices 1320, 1340 (e.g., keyboard, keypad, mouse, touchpad, touchscreen, microphone, etc.).

G. Example Methods of Application

FIG. 22 illustrates a flow diagram of an example method 2200 to personalize an audio equalizer interface based on user feedback through transfer and/or active learning. The example method 2200 can be used to build and/or modify interfaces for reverberation/color balance in photo editing/audio equalization, audio dynamic range compression, etc.

There is an important distinction between learning natural language concepts in order to classify digital objects versus learning concepts in order to manipulate the degree to which an object (e.g., an audio sample in this case) conforms to a given concept. In other words, the artifact itself is changing based on an understanding of the concept (e.g., rather than recommending an existing object, creating a new media object that is not already found in a pool of existing media objects but may be similar in one or more ways to at least a portion of the objects). A parallel in the visual domain would be a controller that alters an image to make the image more or less “Scenic”, rather than restricting the set of images returned on the basis of the learned concept. In this way, certain examples provide utility in more abstract concept spaces that have traditionally been much more difficult for machine-based interaction, but are critical to the design of successful creative tools.

Prior user data can be combined with current user data regarding a same or similar concept (e.g., a characterization or complaint regarding the audio) to reduce an amount the current user is to train the audio equalizer. For example, if the current user's complaint is similar to complaints of others in the past (e.g., “my hearing aid is too tinny”), then a new media object or subset of media objects is generated for the user to rate to determine whether the user identifies with a group of “tinny” users or in fact aligns better with another group despite common word usage.

By looking at user reactions and for similarities as well as differences, a new or updated equalizer interface and/or associated equalization settings can be created. The equalization is personalized for a user but informed by other users that appear to be like the particular user in question. Based on user labels regarding impression of the played sound (e.g., tinny, muddy, etc.), a match is made with other monitored people and their descriptions. Through the combination of current and historical data, accuracy can be improved and repetition can be reduced.

At block 2210, a media object to be manipulated (e.g., a sound file) is selected. For example, a musical passage or song is selected for manipulation. Other media objects can also be selected with equal generality. For example, the media object can be an image.

At block 2220, a goal concept for the media object is labeled (e.g., the “user-concept”). For example, a user is asked to label the goal concept (e.g., “a warm sound”) for the selected media object. Other examples include “bright,” “tinny,” “dark,” “crisp,” “grainy”, etc., for an audio or image object.

At block 2230, a modification of the media object is selected. For example, a type of reverberation can be added. Other modification(s) can be selected at random from an existing set of modifications to try (e.g., resulting in user selection of 25-30 examples). Alternatively, active learning can be used to select modification(s). Using active learning, example modification(s) to be rated are selected by choosing a most informative example the current user has not yet rated. Such selection can be done by selecting an example that provided a largest variance in ratings given by prior users (see, e.g., FIG. 16).

At block 2240, the media object is modified based on the selected modification. The modification or manipulation can produce a number of manipulated samples M. At block 2250, a user rating of how well the modified object embodies the user-concept identified in block 2220 is collected. For example, the manipulated samples M of the modified media object are presented to the user and a rating is obtained from the user in response. For example, the user can move a ratings slider to record his or her rating, such as from −1 (the opposite of the concept) to 1 (perfect embodiment of the concept) for a given user-concept and modified sample. FIG. 19 illustrates an example slider 1910 which a user can move from neutral to very tinny or not at all tinny and/or a point in between. The user can then select to process 1920 the rating to construct an equalization controller based on user rating(s). At block 2260, the rating of the example can be stored (e.g., in a database).

At block 2270, a learning confidence value indicative of whether the system has learned the meaning of the user-concept term is estimated. In an example, the confidence value can be estimated by counting how many examples the user has rated (e.g. 25 examples=sufficient confidence, since research has shown this is the typical number needed to estimate the user-concept). Another example implementation compares the predicted value for the user rating of the most recent example (using Equation 6) to the actual user rating. Once the difference between predicted and actual ratings falls below a threshold (for example, a 10% difference) and stays below it for n examples (for example, 3), system confidence is deemed sufficient to move one. Otherwise, the method 2200 repeats at block 2230 to select a further modification to be applied to the media object.

At block 2280, a model is built to map between different modifications/manipulations and the user-concept. For example, a model provides a gauge as to whether adding or removing reverberation makes a sound “warmer”. A model of the user-concept can be built from only the current user's response to examples (see, e.g., block 2250).

Alternatively, transfer learning can be used to build a model. For example, given user responses, the current user is placed in a space of prior user-concepts. The user-concept model is then built by combining this user's ratings of examples with prior users' ratings of examples that this user has not rated. A weight given to a prior user's ratings depends on how similar the prior user was to the current user in their ratings of examples that the current user did rate. This lets us learn from many more examples than the current user has actually rated while still providing similar results to the base system/method. Active learning selection of a modification (e.g., at block 2230), combined with transfer learning, facilitates building of a user-concept model after rating a small number of examples (e.g., roughly 3 examples).

Transfer learning can include pooled or same word transfer learning, for example. In pooled transfer learning, all available prior user-ratings of examples are used. In same-word transfer learning, the model uses only those ratings that were made in the course of teaching the system a user-concept that has the same label as the user-concept currently being analyzed.

At block 2290, a tool is created to generate examples that can be close or far from embodying the descriptive term (the user-concept). For example the tool can be implemented as a slider on a graphical interface that adds or removes reverberation to make a sound “warmer” or less “warm”. A user can interact with the tool to confirm and/or adjust modification of the media object, for example.

For example, a result of the learning is applied to customize an audio equalizer interface and/or associated sound quality for the user. For example, equalization parameters can be set and/or options provided (e.g., sliders, buttons, bars, etc.) for user audio output (e.g., hearing aid operation, listening to music, etc.). The equalization interface and/or associated parameter(s) can be modified by the user. For example, the user can manually tweak the automatically generated configuration to make further modification to suit his or her needs/preferences.

Thus, in certain examples, a user with a hearing aid walking from outside into a loud restaurant can account for volume, tone, and/or quality changes in audio. The user's restaurant settings can be stored on a central server so that a next time someone comes into a restaurant, the saved settings can be used as a starting point to calibrate and/or otherwise adjust the sound for that user. In certain examples, this learned customization can be applied to music editing or production, etc. Certain examples can be used to help translate between different people's non-standardized, descriptive terms for sounds. For example, a word map can help identify equivalent, similar, or otherwise overlapping terms.

FIG. 23 is a block diagram of an example processor system 2310 that may be used to implement systems, apparatus, and methods described herein. As shown in FIG. 23, the processor system 2310 includes a processor 2312 that is coupled to an interconnection bus 2314. The processor 2312 may be any suitable processor, processing unit, or microprocessor, for example. Although not shown in FIG. 23, the system 2310 may be a multi-processor system and, thus, may include one or more additional processors that are identical or similar to the processor 2312 and that are communicatively coupled to the interconnection bus 2314.

The processor 2312 of FIG. 23 is coupled to a chipset 2318, which includes a memory controller 2320 and an input/output (“I/O”) controller 2322. As is well known, a chipset typically provides I/O and memory management functions as well as a plurality of general purpose and/or special purpose registers, timers, etc. that are accessible or used by one or more processors coupled to the chipset 2318. The memory controller 2320 performs functions that enable the processor 2312 (or processors if there are multiple processors) to access a system memory 2324 and a mass storage memory 2325.

The system memory 2324 may include any desired type of volatile and/or nonvolatile memory such as, for example, static random access memory (SRAM), dynamic random access memory (DRAM), flash memory, read-only memory (ROM), etc. The mass storage memory 2325 may include any desired type of mass storage device including hard disk drives, optical drives, tape storage devices, etc.

The I/O controller 2322 performs functions that enable the processor 2312 to communicate with peripheral input/output (“I/O”) devices 2326 and 2328 and a network interface 2330 via an I/O bus 2332. The I/O devices 2326 and 2328 may be any desired type of I/O device such as, for example, a keyboard, a video display or monitor, a mouse, etc. The network interface 2330 may be, for example, an Ethernet device, an asynchronous transfer mode (“ATM”) device, an 802.11 device, a DSL modem, a cable modem, a cellular modem, etc. that enables the processor system 2310 to communicate with another processor system.

While the memory controller 2320 and the I/O controller 2322 are depicted in FIG. 23 as separate blocks within the chipset 2318, the functions performed by these blocks may be integrated within a single semiconductor circuit or may be implemented using two or more separate integrated circuits.

Thus, certain examples can be applied to program and adjust the frequency gain per band for programmable hearing aids and other audio output devices. Gaussian distribution curves of gain vs. frequency band are produced and applied to certain sounds (e.g., someone singing music, etc.) and rated high, low, etc. by a user and/or automated program. Certain examples quickly map a user's particular vocabulary to what the gain distribution should be for a particular kind of word. Data is collected, slopes are plotted, and a distribution is determined.

In some examples, a correction factor is applied for hearing impaired to make sounds audible to them via a hearing aid and/or other speaker. A person's audiogram is identified to determine how to boost a signal so that the person can hear it.

While certain examples are described with respect to audio equalization, examples are generally related to collaborative filtering of media for which a user rates examples and such examples can be altered and/or added. In the audio processing domain, collaborative filtering methods can apply to compression, equalization, reverberation, etc. Collaborative filtering can also be applied in visual editing (e.g., color balancing of images, etc.).

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Some or all of the system, apparatus, and/or article of manufacture components described above, or parts thereof, can be implemented using instructions, code, and/or other software and/or firmware, etc. stored on a machine accessible or readable medium and executable by, for example, a processor system (e.g., the example processor system 2310 of FIG. 23). When any of the appended claims are read to cover a purely software and/or firmware implementation, at least one of the components is hereby expressly defined to include a tangible medium such as a memory, DVD, CD, Blu-ray, etc. storing the software and/or firmware.

One or more of the components of the systems and/or steps of the methods described above may be implemented alone or in combination in hardware, firmware, and/or as a set of instructions in software, for example. Certain embodiments may be provided as a set of instructions residing on a computer-readable medium, such as a memory, hard disk, Blu-ray, DVD, or CD, for execution on a general purpose computer or other processing device. Certain embodiments of the present invention may omit one or more of the method steps and/or perform the steps in a different order than the order listed. For example, some steps may not be performed in certain embodiments of the present invention. As a further example, certain steps may be performed in a different temporal order, including simultaneously, than listed above.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

One or more of the components of the systems and/or steps of the methods described above may be implemented alone or in combination in hardware, firmware, and/or as a set of instructions in software, for example. Certain embodiments may be provided as a set of instructions residing on a computer-readable medium, such as a memory, hard disk, Blu-ray, DVD, or CD, for execution on a general purpose computer or other processing device. Certain embodiments of the present invention may omit one or more of the method steps and/or perform the steps in a different order than the order listed. For example, some steps may not be performed in certain embodiments of the present invention. As a further example, certain steps may be performed in a different temporal order, including simultaneously, than listed above.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method comprising:
receiving a first label for a first audio concept for a media object;
applying active learning to select a first example not yet rated by a first current user;
collecting a first user rating, by the first current user, of the first example compared to the first audio concept;
applying transfer learning to combine the first user rating with ratings from prior users of examples not yet rated by the first current user to build a model of the first audio concept; and
creating a tool operable by the first user to generate examples close to and far from the first label to modify the media object.

2. The method of claim 1, wherein active learning is applied to select an example that showed a largest variance in ratings given by prior users.

3. The method of claim 1, wherein a weight assigned to ratings from prior users is based on a similarity between the ratings from prior users and the current user's ratings of the same examples.

4. The method of claim 1, wherein transfer learning comprises pooled transfer learning in which all ratings from prior users of examples are used.

5. The method of claim 1, wherein transfer learning comprises same word transfer learning in which only those ratings are used that were made in the course of teaching a user concept with the same label as the first label.

6. The method of claim 1, wherein ratings from prior users are identified by placing a set of audio concepts in a vector space and determining a location within the vector space based on user's ratings of example.

7. The method of claim 1, further comprising estimating a learning confidence value indicative of whether a meaning of the first audio concept has been learned.

8. A system comprising:
a processor configured to generate an interface, the interface receiving a first label for a first audio concept for a media object, the processor configured to:
apply active learning to select a first example not yet rated by a first current user;
collect a first user rating, by the first current user, of the first example compared to the first audio concept;
apply transfer learning to combine the first user rating with ratings from prior users of examples not yet rated by the first current user to build a model of the first audio concept; and
create a tool operable by the first user to generate examples close to and far from the first label to modify the media object.

9. The system of claim 8, wherein active learning is applied to select an example that showed a largest variance in ratings given by prior users.

10. The system of claim 8, wherein a weight assigned to ratings from prior users is based on a similarity between the ratings from prior users and the current user's ratings of the same examples.

11. The system of claim 8, wherein transfer learning comprises pooled transfer learning in which all ratings from prior users of examples are used.

12. The system of claim 1, wherein transfer learning comprises same word transfer learning in which only those ratings are used that were made in the course of teaching a user concept with the same label as the first label.

13. The system of claim 8, wherein ratings from prior users are identified by placing a set of audio concepts in a vector space and determining a location within the vector space based on user's ratings of example.

14. A tangible computer readable medium comprising computer program code which, when executed by a processor, implements a method comprising:
receiving a first label for a first audio concept for a media object;
applying active learning to select a first example not yet rated by a first current user;
collecting a first user rating, by the first current user, of the first example compared to the first audio concept;
applying transfer learning to combine the first user rating with ratings from prior users of examples not yet rated by the first current user to build a model of the first audio concept; and
creating a tool operable by the first user to generate examples close to and far from the first label to modify the media object.

15. The computer readable medium of claim 14, wherein active learning is applied to select an example that showed a largest variance in ratings given by prior users.

16. The computer readable medium of claim 14, wherein a weight assigned to ratings from prior users is based on a similarity between the ratings from prior users and the current user's ratings of the same examples.

17. The computer readable medium of claim 14, wherein transfer learning comprises pooled transfer learning in which all ratings from prior users of examples are used.

18. The computer readable medium of claim 14, wherein transfer learning comprises same word transfer learning in which only those ratings are used that were made in the course of teaching a user concept with the same label as the first label.

19. The computer readable medium of claim 14, wherein ratings from prior users are identified by placing a set of audio concepts in a vector space and determining a location within the vector space based on user's ratings of example.

20. The computer readable medium of claim 14, wherein the method further comprises estimating a learning confidence value indicative of whether a meaning of the first audio concept has been learned.
